(19) United States
(12) Patent Application Publication
(10) Pub. No.: US 2008/0243726 A1
(43) Pub. Date: Oct. 2, 2008

(54) EQUIPMENT USAGE INFORMATION OBTAINING APPARATUS, EQUIPMENT USAGE INFORMATION OBTAINING SYSTEM, EQUIPMENT USAGE INFORMATION OBTAINING METHOD, AND COMPUTER READABLE STORAGE MEDIUM

(76) Inventor: Hiroaki Hasegawa, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/058,100

(22) Filed: Mar. 28, 2008

(30) Foreign Application Priority Data
Mar. 30, 2007 (JP) 2007-094278

(51) Int. Cl. G06F 17/00

(52) U.S. Cl. 705/400

(57) ABSTRACT

Equipment, which are to be checked for the amount of usage of consumables, are extracted based on an agreement ID, and a closing day for checking the amount of usage of consumables specified for each of the extracted pieces of equipment is obtained. A check is subsequently performed, by the closing day, to ascertain whether or not a check date exists on which the amount of usage has been checked by referencing a log which records the amount of usage of consumables. When a check date does not exist in the log, the sequence for checking the amount of usage is changed in accordance with priority level data specified by the agreement ID.

### FIELD OF THE INVENTION

The present invention relates to an equipment usage information obtaining apparatus, an equipment usage information obtaining system, and an equipment usage information obtaining method configured to obtain equipment usage information relating to the use of the equipment, such as counter values and the like in a copying machine.

### BACKGROUND OF THE INVENTION

Conventionally, there are businesses which lease equipment such as a copying machine or the like to a customer, and charge a usage fee that is calculated based on the number of copies printed by the equipment. A counter value which represents the number of printed copies is counted by a counter that is built into the equipment, and the counter value is stored in an internal memory. An employee from the company that leased the equipment then performs the counter check work by reading the counter value from the internal memory of the equipment.

The work of obtaining the counter value from the equipment is referred to as a “counter check.” The target period for which the counter is checked and a customer is charged a usage fee is, for example, one month. When focusing on a particular month, the target period for which a counter check is performed extends from the first day to the last day of the month, and this period is referred to as the “current month.”

Various counter check methods have been used in the counter check work. Examples of counter check methods include a method in which data are obtained through a communication line; a method in which a representative of the customer company checks the counter, enters the counter value on a special form and sends the special form to the service company by postcard or fax; and a method in which a counter check employee visits the location at which the equipment is installed and performs the counter check operation.

There are two types of fee charging method which are determined when the lease agreement is concluded between the service company and the customer company. One such method charges a usage fee that is added to a basic fee, and the other method adds the usage fee of the “current month” to the fee to be charged for the “next month,” rather than the “current month,” when the fee can not be charged the “current month.”

For example, Japanese Patent Application KOKAI Publication No. 2001-69291 discloses a communication system that sends, to a host computer, the counter check data, which measure the quantity of consumables, such as recording paper and the like received from an office automation device, and the host computer determines whether there is an irregularity in the office automation device from the results of an evaluation of the counter check data.

There are times, however, when a counter value cannot be collected due to problems with the communication line, as when the counter check data is transmitted through a telephone line. Furthermore, even when an employee visits the location of the customer to perform the counter check, the counter check may be prevented if the employee cannot enter the location. Additionally, even when a representative of the customer company performs the counter check, the service company may not be able to obtain the counter value if the counter value is not sent to the service company within the period.

Additional time may pass in such cases before it becomes clear that the counter check data cannot be obtained. The counter check work also may not be completed within a specified period (for example, by the last business day of the month) even when the result of the clarification is received and a counter check employee goes to the location. As a result, it may not be possible to charge the customer company a fee.

Problems therefore arise inasmuch as a counter check that accurately reflects actual usage within the “current month” cannot be performed and the fee can not be charged, with the result that the fee which should be charged for the “current month” is added to the charges for the “next month” and only the basic fee is charged for the “current month.”

The counter value may also be entered after returning to the office when the employee visually performs a counter check. There is concern of entry errors, however, when the data is recorded in this way. The capability of mechanically entering the obtained counter values has therefore been requested.

### SUMMARY OF THE INVENTION

In view of the above-mentioned problems, an object of the present invention is to increase the accuracy of the counter check.

A further object of the present invention is to provide a system and the like capable of increasing the work efficiency of the counter check operation.

To achieve these objects, an equipment usage information obtaining apparatus according to a first aspect of the present invention comprises: a usage check indicating unit configured to extract equipment that to be checked for the amount of usage of consumables based on an agreement ID, obtain a closing day on which the amount of usage of consumables is to be checked and which is specified for each piece of extracted equipment, refer to a log that records the amount of usage of consumables, and check for the existence of a check date on which the amount of usage has been checked, by the closing day; and a sequence changing unit configured to change the sequence of checking the amount of usage in accordance with priority level data specified by the agreement ID when a check date does not exist in the log.

The equipment usage information obtaining system of a second aspect of the present invention comprises: a table configured to record a plurality of equipment counter value checking methods that are associated with a priority level, for each piece of equipment; an equipment specifying unit configured to specify target equipment for which to obtain a counter value; and a counter check unit configured to select a checking method from among the checking methods recorded in the table based on a priority level, and perform a counter value checking process according to the selected checking method, for the specified equipment.

The equipment usage information obtaining method of a third aspect of the present invention includes: a step of extracting equipment for which the amount of usage of consumables is to be checked based on an agreement ID; a step of obtaining a closing day on which to check the amount of usage of consumables specified for each of the extracted piece of equipment; a step of referring to a log that records the amount of usage of consumables, and checking for the existence of a check date on which the amount of usage has been checked, by the closing day; and a step of changing the sequence of checking the amount of usage in accordance with priority level data specified by the agreement ID when the check date does not exist in the log.

The equipment usage information obtaining method of a fourth aspect of the present invention stores a program, executable by a computer, for performing: a step of extracting equipment for which the amount of usage of consumables is to be checked based on an agreement ID; a step of obtaining a closing day on which to check the amount of usage of consumables specified for each of the extracted pieces of equipment; a step of referring to a log that records the amount of usage of consumables, and checking for the existence of a check date on which the amount of usage has been checked, by the closing day; and a step of changing the sequence of checking the amount of usage in accordance with priority level data specified by the agreement ID when the check date does not exist in the log.

### BRIEF DESCRIPTION OF THE DRAWINGS

These objects and other objects and advantages of the present invention will become more apparent upon reading of the following detailed description and the accompanying drawings in which:

FIG. 1 is a diagram showing a structural example of an equipment usage information obtaining system according to an embodiment of the present invention;

FIG. 2 is a block diagram showing the functions of the counter check server and DB server;

FIG. 3 is a schematic diagram that partially extracts the field names of the table group included in the DB server;

FIG. 4 is a block diagram describing the counter check function of the equipment usage information obtaining system according to the embodiment;

FIG. 5 is a block diagram describing the function of the counter check slip creating CGI of the counter check server;

FIG. 6 is a diagram showing the relationship of the fields of each table in the DB server;

FIG. 7 is a flow chart illustrating the processes of the PC client and the counter check server from the perspective of preparing an invoice;

FIG. 8 is a flow chart illustrating the counter check process;

FIG. 9 is a flow chart illustrating the counter check changing process; and

FIG. 10 is a flow chart illustrating the counter check process.

### DETAILED DESCRIPTION OF THE PREFERRED EMBODIMENT

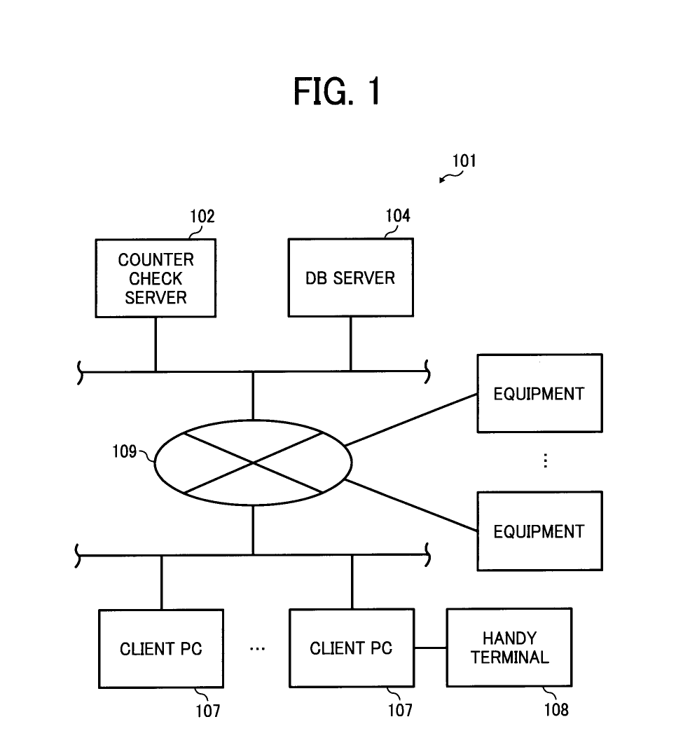

An embodiment of the present invention is described hereinafter with reference to the drawings. The equipment usage information obtaining system according to the embodiment of the present invention is a system configured to support the work of obtaining information (counter value and the like) related to the use of the equipment. Furthermore, the equipment in the embodiment includes copying machines, printers, facsimile machines, scanners, and multifunction apparatuses that include the function(s) of some or all of such equipments. FIG. 1 is a schematic diagram that shows the overall equipment usage information obtaining system according to the embodiment of the present invention.

An equipment usage information obtaining system 101 of the present embodiment comprises a counter check server 102, a DB (database) server 104, a client PC (personal computer) 107, and a counter check handy terminal 108, which is connectable to the client PC 107. The counter check server 102, DB server 104, and client PC 107 are connected through a network 109, such as a LAN (Local Area Network), the Internet or the like.

The client PC 107 is configured by a computer comprising a control unit that includes a CPU, ROM, and RAM, a memory unit that includes a hard disk device, a communication unit that includes a NIC (Network Interface Card), a router, a modem and the like, an input unit that includes a mouse and a keyboard, and a display unit that includes a liquid crystal display. The control unit of the client PC 107 realizes a web browser configured to access the counter check server 102 by executing a program stored in the memory unit.

The handy terminal 108 is configured by a computer comprising a CPU, a memory including ROM, RAM and the like, an input unit, a display unit, and a communication unit. The handy terminal 108 includes a PDA (Personal Digital Assistant) provided with, for example, a dot matrix printer. By executing a program stored in the memory, the CPU of the handy terminal 108 performs processing for connecting to equipment installed at a customer company and obtaining a counter value, and processing for connecting to the client PC 107 and supplying the counter value which was obtained from the equipment. The handy terminal 108 is also capable of printing a counter value and an invoice from a printer connected to the apparatus body, or a printer (not shown in the drawings) which is connected to a LAN within the company.

The counter check server 102 is configured by a computer comprising a control unit that includes a CPU, ROM, and RAM, a memory unit that includes a hard disk device, and a communication unit that includes a NIC, a router, a modem and the like. The control unit of the counter check server 102 realizes a web server program, a counter check slip creating CGI, an invoice creating unit and the like (described later) by executing a program stored in the memory unit.

The DB server 104 is configured by a computer comprising a control unit that includes a CPU, ROM, and RAM, a memory unit that includes a hard disk device, and a communication unit that includes a NIC, a router, a modem and the like. The control unit of the DB server 104 performs processing for receiving read and write requests to and from the various tables stored in the memory unit from the counter check server 102 by executing the program stored in the memory unit. Furthermore, at least either the counter check server 102 or the DB server 104 may also be realized by a plurality of computers so as to ensure load distribution and safety.

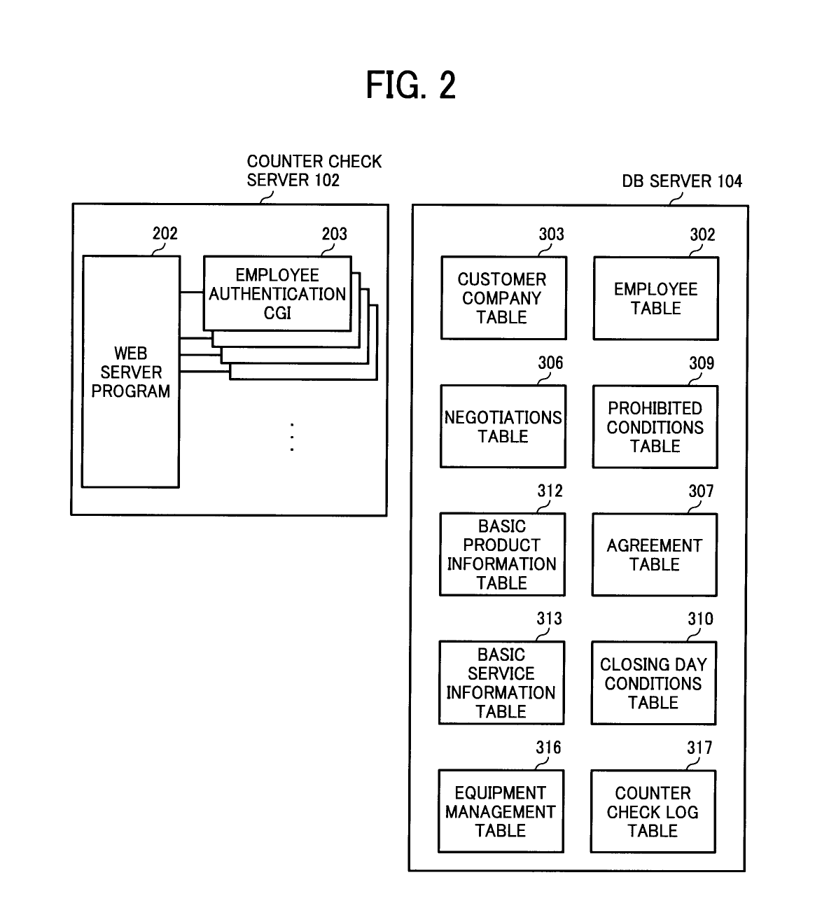

FIG. 2 is a function block diagram of the counter check server 102 and the DB server 104. The counter check server 102 comprises a web server program 202 and many CGIs. The CGIs include an employee authentication CGI 203 configured to authenticate those employees permitted to access the network 109, and a CGI configured to realize the various user interfaces.

The DB server 104 stores a great number of tables configured to store various types of data. FIG. 2 shows a portion of such tables. The DB server 104 comprises an SQL server.

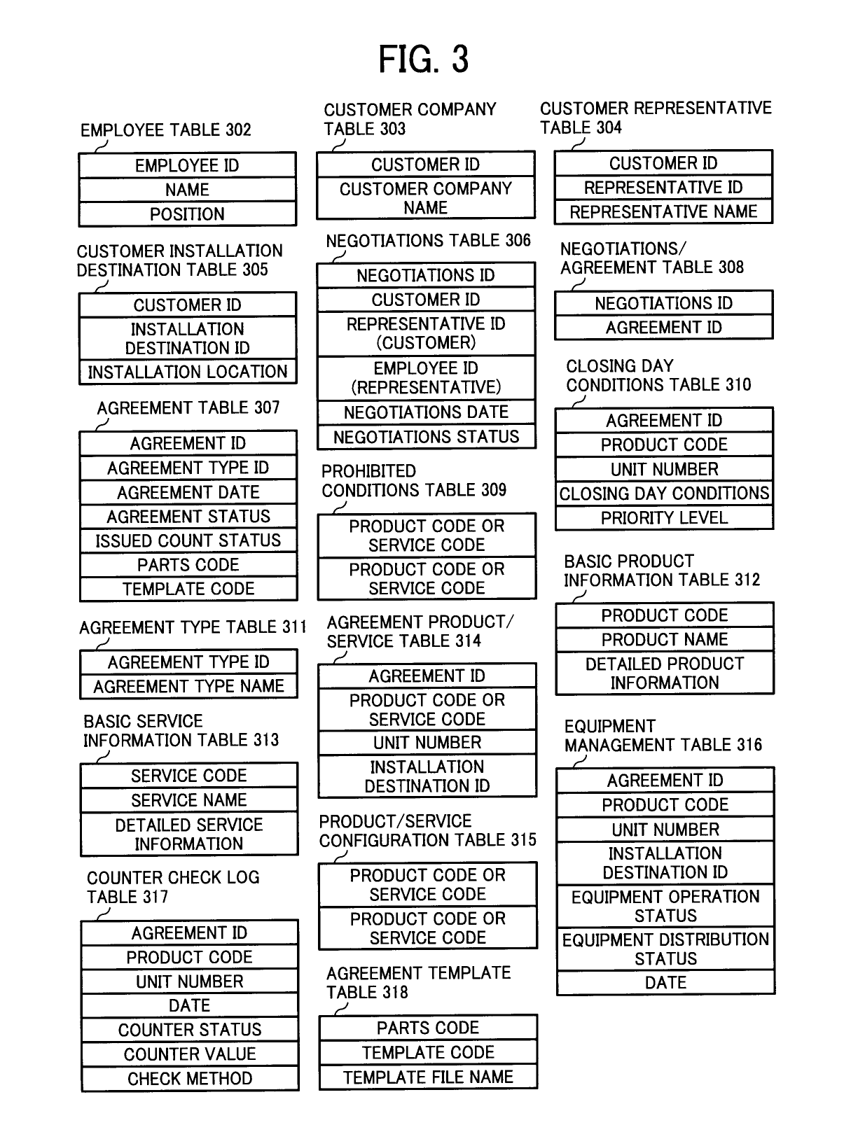

FIG. 3 is a diagram in which the field names of the table group stored in the memory unit of the DB server 104 have been partially extracted. An employee table 302 includes a “Employee ID” which uniquely identifies the employee, “Name” and “Position” of the employee, as well as a hash value (not shown in the drawing) of the password used for employee login identification and the like. The employee who visits the customer company and concludes a contract agreement is referred to as the “sales representative.”

A customer company table 303 includes fields such as “Customer ID” which uniquely identifies the customer company, and “Customer Company Name.” In a case where a desired customer company name is to be displayed on the display screen of the client PC 107, the value of the “Customer Company Name” field is acquired from the customer company table 303.

A customer representative table 304 includes fields such as “Representative ID” which uniquely identifies the customer representative, “Representative Name,” and “Customer ID” which indicates the customer company.

A customer installation destination table 305 includes fields such as “Installation Destination ID” which uniquely identifies the installation location (installation destination) where the equipment sold to the customer is to be installed, “Installation Location,” and “Customer ID.”

A negotiations table 306 includes fields such as “Negotiations ID” which uniquely identifies negotiations, “Negotiations Date” which indicates the date the negotiations started, “Negotiations Status” which indicates the progress and result of negotiations (preliminary agreement, agreement established, agreement failed and the like), “Customer ID,” “Representative ID,” and “Employee ID.” A new record of this negotiations table 306 is created when the sales representative begins negotiations with the customer.

An agreement table 307 includes fields such as “Agreement ID” which uniquely identifies an agreement, “Agreement Type ID,” “Agreement Date” which indicates the date the agreement was concluded, “Agreement Status” which indicates the progress and result of the agreement (preliminary agreement, agreement established, agreement failed and the like), “Issue Count Status” which stores the count of agreements formally issued, “Parts Code” which indicates the parts included in the agreement, and “Template Code” which indicates the template file determining each of the parts included in the agreement. One record of this agreement table 307 is newly created per agreement.

A negotiations/agreement table 308 comprises groups of “Negotiations ID” and “Agreement ID” values, indicating the relationship between the negotiations and agreements. For example, a plurality of agreements may result from a single negotiation. The negotiations/agreement table 308 enables the user to find the negotiations ID from the agreement ID, or the reverse.

A prohibited conditions table 309 describes “Product Code” and “Service Code” combinations of products and services that cannot be sold together in a quotation when the sales representative proceeds with negotiations.

A closing day conditions table 310 describes the agreement conditions related to the closing day for checking the counter of the equipment, such as a copying machine. The closing day conditions table 310 includes fields such as “Agreement ID” which indicates the agreement affiliated with the equipment, “Product Code” which indicates the product code of the equipment, “Unit Number” which indicates the serial number per equipment, “Closing Day Conditions” which indicates the conditions (checking method, closing date and the like) of the closing day for checking the counter value of the equipment, and “Priority Level” which indicates the priority level of the “Closing Day Conditions.” In the present embodiment, different closing days are set depending on the counter check method used. That is, the closing day is changed by changing the counter checking method. Furthermore, the priority level of each counter checking method is set per unit number. The operation of obtaining a counter value is performed by the set closing day by using a counter check method with a high priority level.

An agreement type table 311 includes fields such as “Agreement Type ID” and “Agreement Type Name.” Agreement types include “Sale Agreement,” “Part Maintenance Agreement,” and “Performance Agreement.”

A basic product information table 312 includes fields such as “Product Code” which uniquely identifies a product, “Product Name,” and “Detailed Product Information.

A basic service information table 313 includes fields such as “Service Code” which uniquely identifies a service, “Service Name,” and “Service Detailed Information.”

An agreement product/service table 314 describes the relationship between the agreement and products or services. This table comprises groups of “Agreement ID” and “Product Code” or “Service Code” values. For example, a plurality of products or services may arise in a single agreement. This agreement product/service table 314 also includes fields such as “Unit Number” and “Installation Destination ID.”

A product/service configuration table 315 indicates the products and services that make up a product or service, and describes the relationship of the configuration using “Product Code” and “Service Code” values. For example, a copy machine unit comprises hardware options such as a sorter, an automatic double-sided original feeding device, a stapler, and software options for achieving a facsimile function, a printer function, and a scanner function and the like. Furthermore, the copy machine also involves applicable maintenance services. Therefore, a product sometimes includes optional products and services as well. For example, a service that includes the provision of a PC maintenance service and an anti-virus software product may exist under the name “Security Pack.” A service therefore sometimes includes a product as well. A table is therefore provided to describe the configurations of products and/or services.

An equipment management table 316 is a table that plays a core role in the present embodiment. The equipment management table 316 is a table configured to uniquely identify one piece of equipment (one product) using a “Product Code” and “Unit Number,” and manage the life of the equipment from delivery to the customer to disposal or recycling, storing the dates and status information in detail accordingly. The equipment management table 316 includes fields such as “Product Code,” “Unit Number,” “Agreement ID” which indicates the agreement affiliated with the equipment, “Installation Destination ID” which indicates the location at which the equipment is installed, “Equipment Operation Status” and “Equipment Distribution Status” which indicate the status of the equipment, and “Date” which indicates the date on which the various status information was recorded.

A counter check log table 317 mainly records the numeric value of the “counter” that is built into the copy machine and incremented each time the copy machine is used. The copy machine equipment comprises a mechanism for charging for usage in accordance with a usage count, that is, the number of sheets consumed by copy output. Here, on the determined closing day of each month, the value of the counter built into the copy machine is checked and stored in the counter check log table 317. The counter check log table 317 includes fields such as “Product Code,” “Unit Number,” “Agreement ID” which indicates the agreement affiliated with the equipment, “Counter Value,” “Date” which indicates the date on which the counter value was acquired, “Counter Status” which indicates the status under which the counter value was acquired, and “Check Method” which indicates which counter checking method was used when the counter value was acquired.

An agreement template table 318 stores a “Parts Code” configured to identify the model parts required in the agreement, a “Template Code” configured to identify the template, and a “Template File Name.” The model data of the agreement corresponding to the parts code and template code is registered in the agreement template table 318 as a template file. The agreement is created by combining the five parts described below. Note, however, that some parts are required in certain agreements but not in others. The following five parts make up a basic pattern. “Cover sheet”: A part that expresses the agreement relationship between party A and party B. “Basic terms”: A part that expresses the required “basic terms” for the sale. “Service terms”: A part that expresses the “basic terms” for added value, such as maintenance service, but not for an object (such as a copy machine or PC, for example). “Agreement fee”: A part that expresses the fee at the time of the quotation. “Maintenance details”: A part that expresses what will be serviced in a case where maintenance service is to be subscribed.

### Counter Check Function

The system according to the present embodiment supports the work of performing a counter check and requesting a usage fee from a customer company which has concluded a performance agreement. The counter check function performed by the equipment usage information obtaining system 101 is largely accomplished through the following process. The counter value of the copying machine must be checked by the closing day of each month. There may be occasions, however, when the counter value cannot be checked by the closing day, depending on the customer. At such times, reference is made to the closing day conditions table 310 created when the agreement was created, or the counter check log table. The representative is provided with suitable instructions by checking when and what counter check operation is to be performed and whether the operation has already been completed, then creating counter check instructing data for creating a counter check slip to instruct the representative.

### Counter Check Details

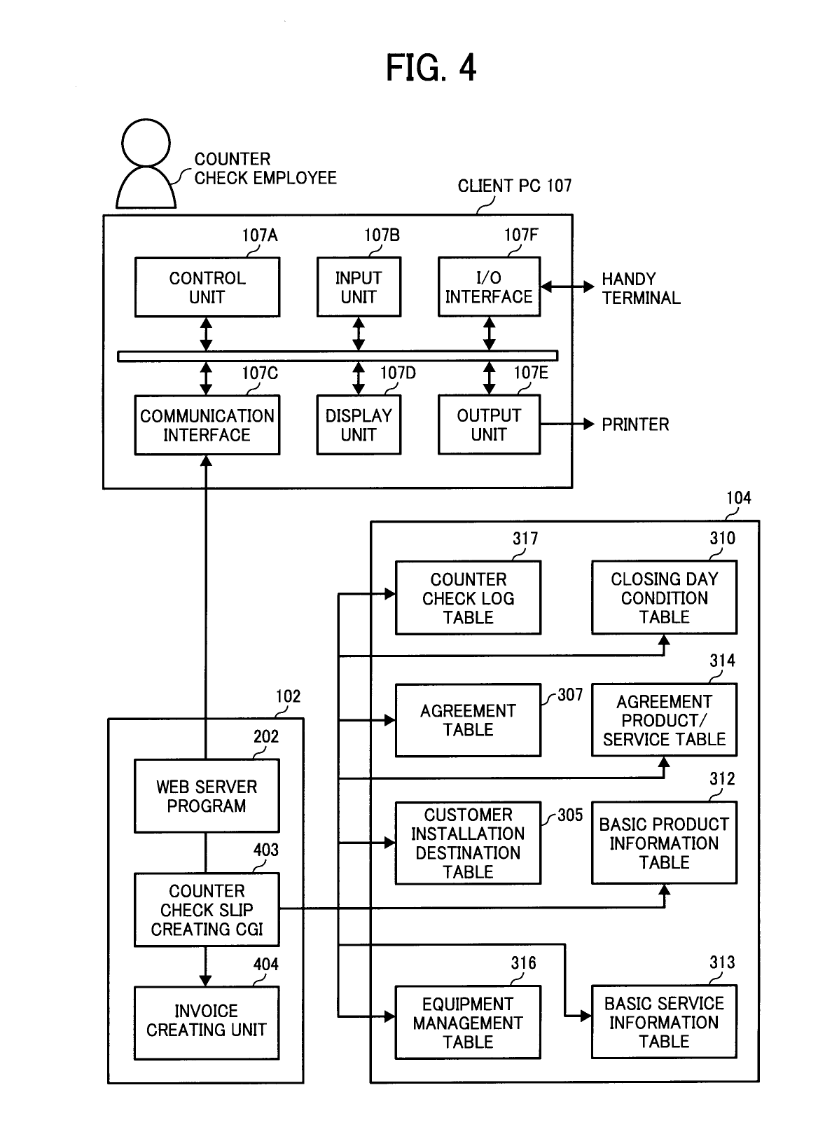

FIG. 4 is a block diagram illustrating the counter check function which is one of the features of the equipment usage information obtaining system 101 of the present embodiment.

The client PC 107 comprises a control unit 107a, an input unit 107b which receives input of letters and numbers, a communication interface 107c which is an interface configured to send and receive data to and from the counter check server 102, a display unit 107d comprising a liquid crystal display or the like configured to display a counter check operation screen, an output unit 107e configured to output the print data of the counter check slip and the like to a printer (not shown in the drawing) connected to the client PC 107, and an input/output interface 107f which is an interface configured to obtain a counter value from the counter check handy terminal 108 and provide the equipment information of the customer company to the counter check handy terminal 108. The output unit 107e is configured to output print data such as a counter check work slip to an employee, and a counter check work slip to the representative of the customer company. In the following description, the counter check work slip used in the counter check operation is simply referred to as a “Counter Check Slip.”

The employee who performs the counter check work at the service company operates the client PC 107 to access the counter check server 102 installed at the sales company. The counter check employee is authenticated by the authentication CGI of the counter check server 102 via the user ID and password entered in the client PC 107. The counter check server 102 responds to the access request (HTTP request message) received from the client PC 107, and performs predetermined processing. In the predetermined processing, data acquisition and data writing using SQL are performed in the various types of tables stored in the DB server 104. The arrows that extend from a counter check slip creating CGI 403 to each table in FIG. 4 correspond to this processing. The counter check server 102 includes the web server program 202, the counter check slip creating CGI 403, and an invoice creating unit 404. Although many additional CGIs also exist, only those directly related to the present embodiment have been extracted and described in FIG. 4.

The web server program 202 is configured as an HTTP server, and transmits an HTML document, or CGI execution result that corresponds to the client request (HTTP request message) received via the network 109, in the format of an HTTP response message. One such message, for example, is Apache (http://www.apache.org/).

The counter check slip creating CGI 403 creates an HTML document to be displayed on the web browser of the client PC 107. Furthermore, the counter check slip creating CGI 403 and the invoice creating unit 404 include an SQL client function, access each table of the DB server 104, and acquire the desired data.

The DB server 104 comprises an SQL server, and has an interactive database engine program configured to read and execute inputted SQL language, and combinations of data file groups that make up the various tables.

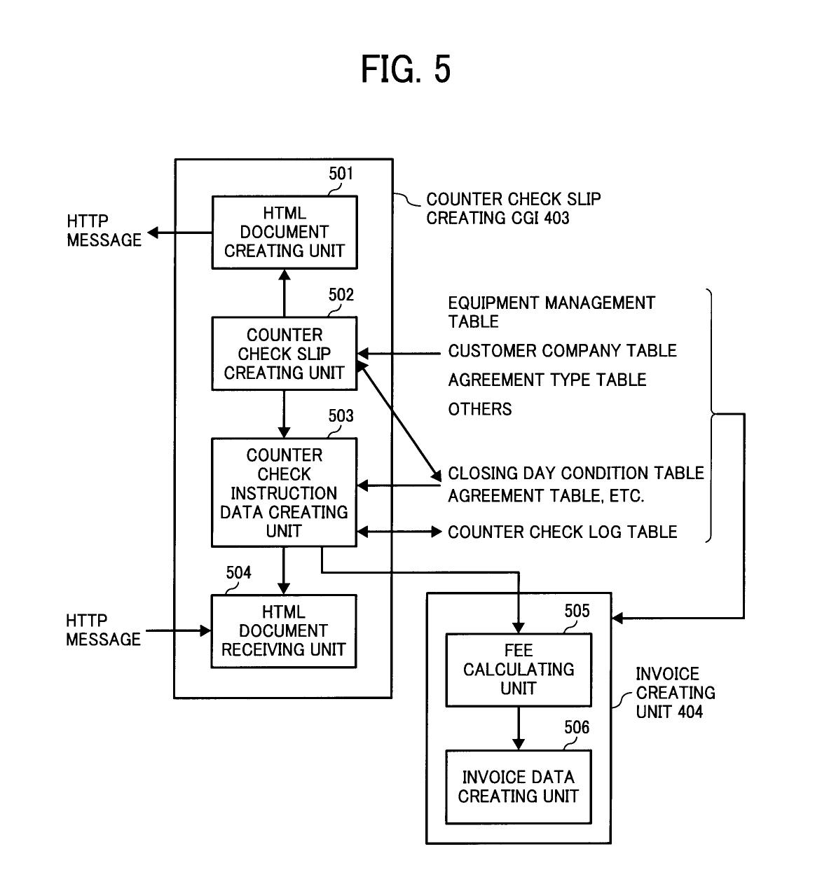

FIG. 5 is a block diagram illustrating the functions of the counter check slip creating CGI 403 in the counter check server 102. The counter check instruction data creating unit 503, which is configured to obtain data required for each item of the counter check slip, obtains the necessary information to create the counter check instruction data from the customer company table 303, the agreement table 307, the closing conditions table 310, the agreement type table 311, and the counter check log table 317. The counter check instruction data creating unit 503 then extracts the equipment to be subjected to the counter check based on the agreement ID and obtains the closing day of the counter check specified for each extracted piece of equipment. Further, a check is made as to whether a check date of a completed counter check exists by the closing day by referencing the counter check log table 317 which stores counter values. When a check date has not been stored in the counter check log table 317, the closing day conditions table 310 is referenced and the sequence of checking the counter value is changed in accordance with the priority level data specified by the agreement ID. Then, the counter check instruction data creating unit 503 supplies the created counter check data to the counter check slip creating unit 502. The counter check slip creating unit 502 creates image data of the counter check slip based on the counter check instruction data.

An HTML document creating unit 501 creates an HTML document from the image data of the counter check slip, and sends the document as an HTML message to the client PC 107. The counter value of each piece of equipment for which a counter check value has been obtained by the counter check employee is received by the client PC 107 and transmitted to the counter check server 102. An HTML document receiving unit 504 of the counter check server 102 receives the counter values. When a counter value has not been obtained by the closing day, the counter check instruction data creating unit 503 creates counter check instruction data which has a changed closing day and counter check method, and supplies the data to the counter check slip creating unit 502.

When a counter value has been obtained by the closing day, the counter check instruction data creating unit 503 supplies the counter value to a fee calculating unit 505 which calculates the fee. The fee calculating unit 505 calculates the fee charged for the “current month” and creates charge data. The charge data is supplied to an invoice data creating unit 506 which creates an invoice for the customer company. The invoice data creating unit 506 creates image data of the invoice, and issues an invoice from a printer which is not shown.

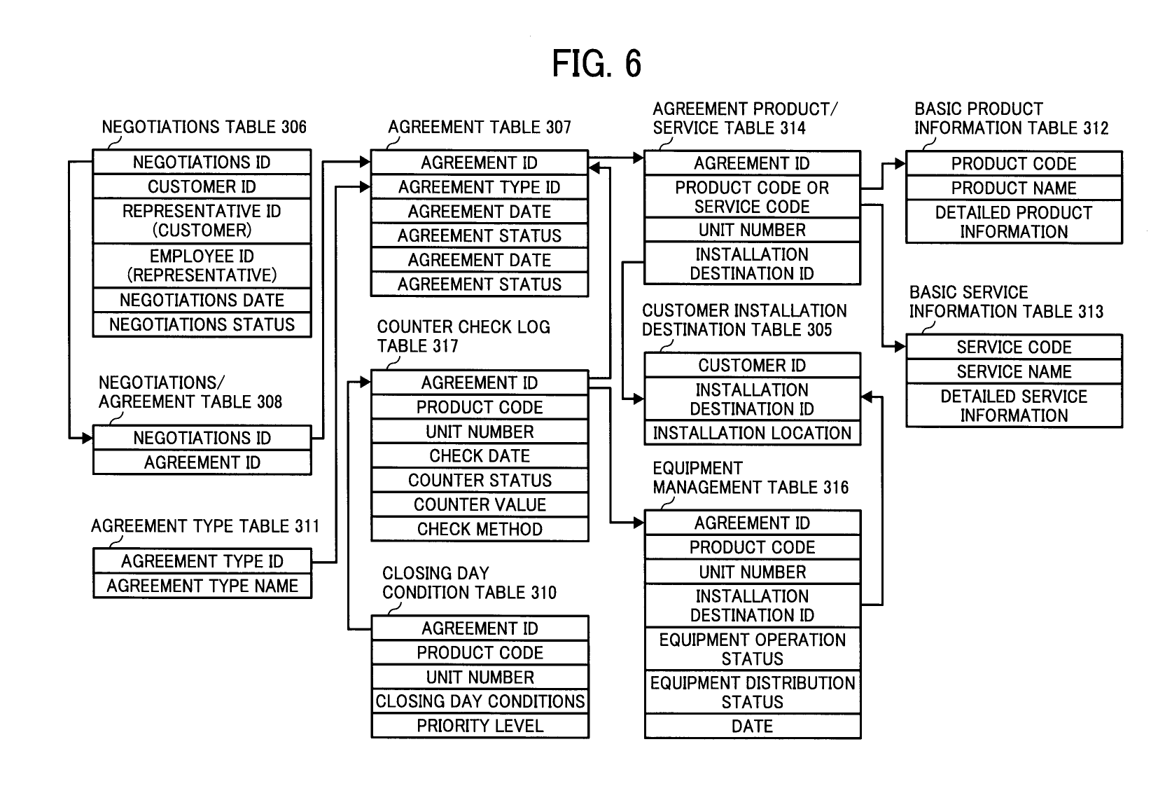

FIG. 6 is a diagram showing the relationships among the fields of each table in the DB server 104 of FIG. 4. The counter check slip creating CGI 403 obtains information concerning the negotiations by searching the negotiations table 306 using the negotiations ID established by the negotiations with the customer. The counter check slip creating CGI 403 then searches the negotiations/agreement table 308 using the negotiations ID, and obtains one or more agreement IDs of the corresponding agreement(s). Next, the counter check slip creating CGI 403 obtains various information concerning the agreement by searching the agreement table 307 using the agreement ID. The counter check slip creating CGI 403 then obtains various information concerning the type of agreement by searching the agreement type table 311 using the agreement type ID. The counter check slip creating CGI 403 also obtains a product code or service code, and an installation destination ID by searching the agreement product/service table 314 using the agreement ID. Next, the counter check slip creating CGI 403 obtains various information concerning the product by searching the basic product information table 312 using the product code. The counter check slip creating CGI 403 also obtains various information concerning services by searching the basic service information table 313 using the service code. Furthermore, the counter check slip creating CGI 403 obtains various information concerning the installation destination by searching the customer installation destination table 305 using the installation destination ID. The counter check slip creating CGI 403 thereafter obtains various information concerning the installation destination by searching the equipment management table 316 using the agreement ID and the installation destination ID. Thus, the counter check slip creating CGI 403 can acquire data with the information of each table linked, making it possible to create the counter check instruction data.

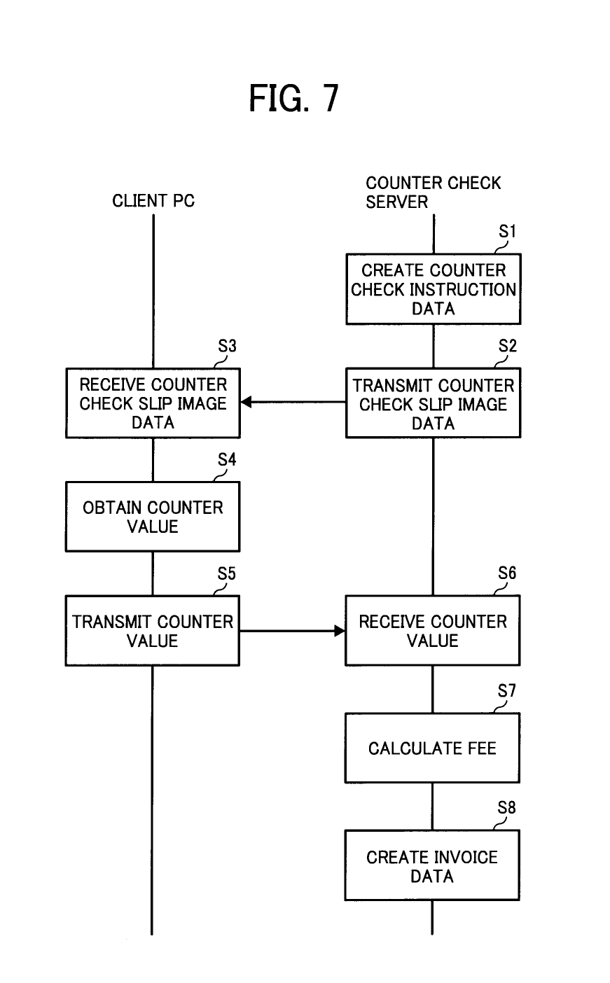

FIG. 7 is a flow chart illustrating the processes of the client PC 107 and the counter check server 102 from the perspective of preparing an invoice. The counter check server 102 first creates the counter check instruction data (step S1). The counter check slip image data which was created based on the counter check instruction data is then transmitted to the client PC 107 (step S2). The client PC 107 receives the counter check slip image data (step S3), and issues the counter check slip by printing. The counter check slip is used to list the equipment on which the counter check employee of the service company is to perform a counter check within the “current month.” When the counter value of the equipment is obtained (step S4), the client PC 107 then transmits the counter value to the counter check server 102 (step S5). The counter check server then receives the counter value (step S6). The counter check server 102 calculates the fee to be charged for the “current month” based on the received counter value (step S7). Thereafter, charge data is created which is the basis of an invoice to be sent to the customer company (step S8).

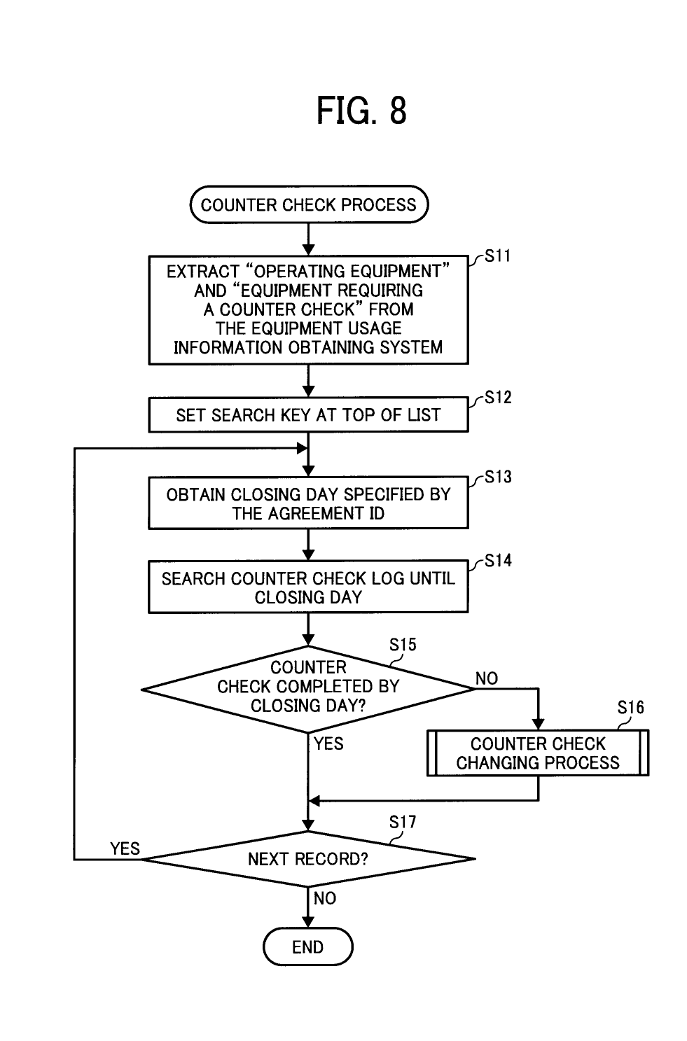

FIG. 8 is a flow chart illustrating the counter check process. First, the counter check server 102 extracts the “operating equipment” and the “equipment requiring a counter check” from the DB server 104 of the equipment usage information obtaining system 101 (step S11), and makes a list. Then, the search key is set at the top of the list (step S12). Next, the closing day for performing the counter check of the equipment is obtained from the agreement information specified by the agreement ID (step S13). The counter check log table 317 is then searched and data concerning the counter check status up to the previous month is obtained (step S14). The counter check server 102 then judges whether or not a counter check has been completed by the closing day (step S15). When a counter check cannot be done by the closing day (step S15: NO), a counter check changing process is performed which will be described later (step S16). When a counter check is completed by the closing day (step S15: YES), a judgment is made as to whether or not a next record exists (step S17). When a next record exists (step S17: YES), the routine returns to the process of step S13, and the process of obtaining a closing day for performing the equipment counter check continues. The process ends when a next record does not exist (step S17: NO).

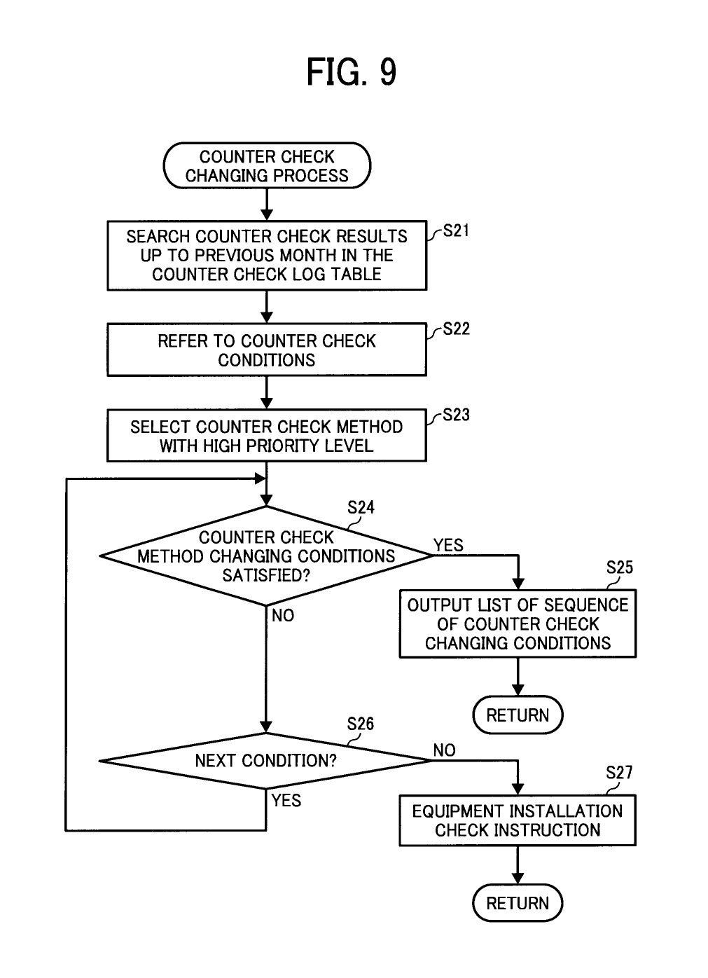

FIG. 9 is a flow chart illustrating the counter check changing process. The counter check server 102 first searches for counter check results up to the previous month by obtaining check dates from the counter check log table 317 (step S21). Then, the counter check conditions specified by the agreement ID are referenced (step S22). When a counter value cannot be obtained by the closing day, a counter check method which has a high priority level is selected and a closing day for performing the counter check is determined in the counter check conditions. The counter check server 102 then references the closing day conditions table 310 and selects a high priority level counter check method for the unit number specified by the agreement ID (step S23). The counter check server 102 then judges whether or not the change conditions of the counter check method are satisfied (step S24). The change conditions of the counter check method are conditions configured to judge whether or not a counter check method can be switched to a counter check method which has the next highest priority level when a counter value cannot be obtained by the closing day by the counter check method that has the highest priority level. When the counter check method has been changed to the counter check method with the next highest priority level, the closing day specified by this counter check method can be newly set.

When the change conditions of the counter check method are satisfied (step S24: YES), the list based on the changed counter check method is output (step S25), and the routine returns to the counter check process (refer to FIG. 8). When the change conditions of the counter check method are not satisfied (step S24: NO), a judgment is made as to whether or not the method can be changed to the next counter check method (step S26). When the method can be changed to the next counter check method (step S26: YES), the routine returns to the process of step S24 and the method is changed to the counter check method which has the next highest priority level. Further, when the counter check method is not changeable (step S26: NO), instruction data are created that instruct the sales representative to visit the installation location of the equipment and perform an on-site check (step S27).

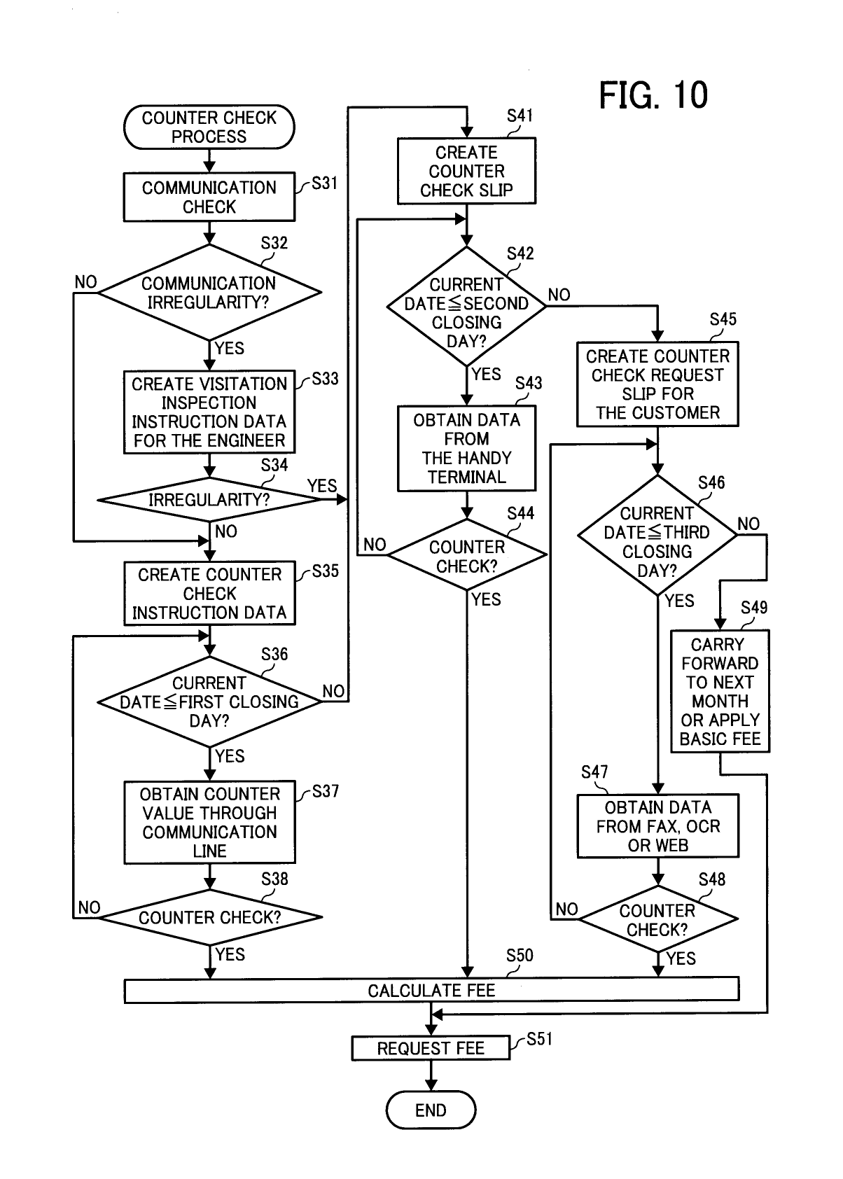

FIG. 10 is a flow chart illustrating the counter check process. In this example, a CSS (Customer Support System) acquisition is set for a first closing day, a visit acquisition is set for a second closing day, and a counter check request set for a third closing day are established in sequence from the highest priority level of the counter check method. Naturally, the priority level changes and the closing day also changes according to the setting.

CSS acquisition is a method configured to acquire the counter value of the equipment through a communication line. CSS is a remote diagnosis and automatic counter check system which uses a public line. The CSS has the functions of preventing equipment breakdown before it happens, and minimizing the period during which equipment is disabled when a breakdown does occur. The CSS is also a system which is capable of automatically transmitting counter values by the first closing day.

Visitation acquisition is a method in which a counter check employee visits a customer company and performs a counter check by the second closing day. The counter check employee receives a counter check slip issued by the counter check server 102, and visits the installation location of the equipment. The employee then inputs the numerical value of the counter value, or connects to the equipment and obtains the counter value using the counter check handy terminal 108.

The counter check request is a method in which a representative of the customer company is relied upon to perform the counter check by the third closing day when admission to the location at which the equipment is installed is prohibited due to security concerns. In this case, the counter check server 102 issues a counter check request slip, and transmits the request to the representative of the customer company by electronic mail. The counter value, which has been obtained by the representative of the customer company who received the counter check request slip, is then transmitted to the service company by web page, fax, or postcard. The counter check employee of the service company converts and transmits the data to the counter check server 102 in the case of counter values obtained from a web page. Similarly, counter values received by fax or postcard are read by OCR, or the client PC 107 obtains the data by key input, and the data is then transmitted to the counter check server 102.

A communication check is first performed between the counter check server 102 and the equipment undergoing a counter check (step S31), and the presence or absence of a communication irregularity is judged (step S32). When there is a communication irregularity (step S32: YES), visitation inspection instruction data are created which direct an engineer to visit the installation location and inspect the equipment that is to undergo a counter check (step S33). As a result of the engineer performing the visitation inspection, a judgment is made as to whether or not the communication irregularity persists in the equipment to undergo a counter check (step S34). When a communication irregularity persists in the equipment to undergo a counter check (step S34: YES), instruction data (counter check slip) are created to switch the counter check method to having an employee visitation check (step S41).

When there is no communication irregularity in the process of step S32 (step S32: NO), or when the communication irregularity has been resolved in the process of step S34 (step S34: NO), the counter check server 102 creates counter check instruction data (step S35). The counter check server 102 then compares the relative relationship between the current date and the first closing day (step S36). Further, the system date obtained by the counter check server 102 may be used as the current date.

When the current date is before the first closing day (step S36: YES), a process for acquiring the counter value is performed through the communication line (step S37). As a result, a judgment is made as to whether or not the counter check could be completed (step S38). When the counter check has been completed (step S38: YES), a fee calculation is performed (step S50). When the counter check cannot be performed (step S38: NO), the routine returns to the process of step S36, and the process of acquiring a counter value through the communication line continues until the first closing day has passed.

When the current date is after the first closing day in step S36 (step S36: NO), that is, when the counter value cannot be acquired by the CSS by the first closing day, the counter check server 102 sets the second closing day and creates visitation data (counter check slip) to direct a counter check employee to visit the installation location of the equipment (step S41). The counter check server 102 then compares the relative relationship between the current date and the second closing day (step S42). When the current date is before the second closing day (step S42: YES), the counter check employee visits the installation location of the equipment and obtains the counter value from the equipment using the handy terminal 108 (step S43). The obtained counter check value is inputted to the counter check server 102.

As a result, a judgment is made as to whether or not the counter check could be completed (step S44). When the counter check has been completed (step S44: YES), a fee calculation is performed (step S50). When the counter check cannot be performed (step S44: NO), the routine returns to the process of step S42, and the process of issuing a counter check slip to direct a counter check employee to visit the location of the equipment continues until the second closing day has passed.

When the current date is after the second closing day in step S42 (step S42: NO), that is, when a counter value cannot be obtained by the counter check employee by the second closing day, the counter check server 102 sets the third closing day, and issues a counter check request slip to request that a representative of the customer company perform the counter check (step S45).

The counter check server 102 then compares the relative relationship between the current date and the third closing day (step S46). When the current date is before the third closing day (step S46: YES), data acquisition continues and data is acquired from a fax or postcard which records the counter value sent by the customer company representative, or data is acquired from a web screen (step S47).

As a result, a judgment is made as to whether or not the counter check could be completed (step S48). Further, there may be occasions when the counter check is performed incorrectly due to misreading of a numerical values, or illegibility of characters when a representative of the customer company performs the counter check. When the counter check has been completed (step S48: YES), a fee calculation is performed (step S50). When the counter check cannot be performed (step S48: NO), the routine returns to the process of step S46, and reception of a counter value sent by the customer company representative is awaited until the third closing day has passed. When a counter check cannot be performed by the third closing day (step S46: NO), the fee for the “current month” is carried forward to the invoice for the “next month,” or the basic fee is applied pursuant with the contents of the agreement previously concluded with the customer (step S49). After the fee has been calculated by the process of step S49 or step S50, a usage fee invoice is issued to the customer (step S51).

According to the present embodiment described above, when a counter check cannot be performed by the closing day according to a particular count check method, it is possible to obtain a counter value within the “current month” by switching to another counter check method. A closing day is set within the “current month” by the respective counter check methods. When a counter check cannot be performed, the counter check method is switched according to priority levels. Thus, an obtained counter value has a high degree of reliability since it is possible to switch to a plurality of counter check methods to set a plurality of closing days within the “current month” so as to reliably obtain a counter value. Further, an appropriate fee can be charged according to a more accurate counter value, with the effect of improving customer satisfaction. The efficiency of the work of obtaining a counter value is also improved.

Further, when the counter check is performed on the set closing day, it is possible to calculate a fee and issue an invoice immediately. Heretofore, when a counter check has been performed at the end of the month, only a handwritten invoice could be issued when the customer company desired an end-of-month invoice. According to the present invention, however, it is possible to issue an invoice immediately at the convenience of the customer without creating separate invoices. Therefore, the number of operations involved in performing a counter check can be reduced, and the fee charged to the customer company has increased reliability.

Heretofore, when a counter value could not be obtained through a communication line, urgent counter check work would have to be performed, thus impacting the deployment of employees and affecting normal work. According to the present invention, however, an employee who performs the counter check can perform the counter check by visiting only those locations requiring attention only when necessary. Therefore, efficient counter check work can be performed since it is easy to plan for the distribution of personnel, and irregular personnel distribution becomes unnecessary.

When a counter check cannot be performed, the basic fee alone may be applied to the “current month” or the fee to be charged for the “current month” can be charged to the “next month.” Therefore, urgent counter check work can be avoided at the end of the “current month,” effectively avoiding any influence on normal work.

Although the period for performing the counter check is set within the “current month,” the period may be, for example, set within two weeks, or within three months. It is possible to freely change the relative length of the period according to the agreement with the customer.

Although the present invention has been described by way the example of the embodiment, the present invention is not limited to the above-described embodiment and, needless to say, various modifications and changes in application may be made thereunto without departing from the broad spirit and scope of the invention described in the claims.

The storage medium that stores the program and data for achieving the equipment usage information obtaining system of the present invention may be, specifically, a CD-ROM (-R/-RW), magnetic optical disk, DVD-ROM, FD, flash memory, memory card, memory stick, or other ROM or RAM. Then, the storage medium is distributed and the program and the like are installed in a computer so as to construct the counter check server, DB server and the like that are to execute the above-described processing. The program may also be stored on a disk device of the server apparatus on a network such as the Internet, and downloaded to the computer, for example, on carrier waves.

In a case where the above-described functions are realized in part by the OS or by an OS and application combination, simply the section other than the OS may be stored on the medium and distributed, or downloaded to the computer on carrier waves.

Various embodiments and changes may be made thereunto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

This application is based on Japanese Patent Application No. 2007-094278 filed on Mar. 30, 2007 and including specification, claims, drawings and summary. The disclosure of the above Japanese Patent Application is incorporated herein by reference in its entirety.

What is claimed is:

1. An equipment usage information obtaining apparatus, comprising:
a usage check indicating unit configured to extract the equipment to be checked for the amount of usage of consumables based on an agreement ID, obtain a closing day on which said amount of usage of consumables is to be checked and which is specified for each piece of said extracted equipment, refer to a log that records said amount of usage of consumables, and check for the existence of a check date on which said amount of usage was checked, by said closing day; and
a sequence changing unit configured to change the sequence of checking said amount of usage in accordance with priority level data specified by said agreement ID when said check date does not exist in said log.

2. An equipment usage information obtaining system, comprising:
a table configured to record a plurality of equipment counter value checking methods that are associated with a priority level, for each piece of equipment;
an equipment specifying unit configured to specify target equipment for which to obtain a counter value; and
a counter check unit configured to select a checking method from among the checking methods recorded in said table based on a priority level, and perform a counter value checking process according to the selected checking method, for said specified equipment.

3. The equipment usage information obtaining system according to claim 2, wherein:
each counter value checking method is recorded and respectively associated with a closing day in said table; and
said counter checking unit determines whether the closing day associated with a selected checking method has passed, and selects the checking method of the next priority level when the closing day has passed.

4. The equipment usage information obtaining system according to claim 2, wherein said equipment usage information includes a counter value stored in the equipment.

5. An equipment usage information obtaining method, comprising:
a step of extracting equipment for which the amount of usage of consumables is to be checked based on an agreement ID;
a step of obtaining a closing day on which to check the amount of usage of consumables specified for each of said extracted equipment;
a step of referring to a log that records said amount of usage of consumables, and checking for the existence of a check date on which said amount of usage was checked, by said closing day; and
a step of changing the sequence of checking said amount of usage in accordance with priority level data specified by said agreement ID when said check date does not exist in said log.

6. A computer readable storage medium configured to store a program, executable by a computer, for performing:
a step of extracting equipment for which the amount of usage of consumables is to be checked based on an agreement ID;
a step of obtaining a closing day on which to check said amount of usage of consumables specified for each of said extracted equipment;
a step of referring to a log that records said amount of usage of consumables, and checking for the existence of a check date on which said amount of usage has been checked, by said closing day; and
a sequence changing unit configured to change the sequence of checking said amount of usage in accordance with priority level data specified by said agreement ID when said check date does not exist in said log.
